(19) United States
(12) Patent Application Publication
(10) Pub. No.: US 2024/0092205 A1
(43) Pub. Date: Mar. 21, 2024

(54) Non-Fluid Cooled Electric Vehicle Fast-Charge Cable

(71) Applicant: RSCC Wire & Cable LLC, East Granby, CT (US)

(72) Inventors: Gil SHOSHANI, Wallingford, CT (US); Phil LAUDICINA, The Woodlands, TX (US); Altin DABULLA, Naples, FL (US)

(21) Appl. No.: 18/500,105

(22) Filed: Nov. 1, 2023

Related U.S. Application Data
(63) Continuation-in-part of application No. 17/588,029, filed on Jan. 28, 2022.
(60) Provisional application No. 63/143,146, filed on Jan. 29, 2021.

(51) Int. Cl. B60L 53/302; B60L 53/10; B60L 53/18; H01B 7/18; H01B 7/42; H02J 7/00

(52) U.S. Cl. CPC B60L 53/302; B60L 53/11; B60L 53/18; H01B 7/1875; H01B 7/423; H02J 7/0042

(57) ABSTRACT

A non-fluid cooled fast-charge electric vehicle (EV) cable includes a pair of cabled insulated conductors, a binder, a thermal layer of a synthetic porous material having extremely low density and extremely low thermal conductivity in a blanket, with a fiberglass cover and a jacket.

### RELATED APPLICATIONS

This application is a continuation-in-part of U.S. patent application Ser. No. 17/588,029, filed Jan. 28, 2022, which claims priority to U.S. Provisional Application No. 63/143,146, filed on Jan. 29, 2021, each of which are hereby incorporated herein by reference in their entirety for all purposes.

### FIELD OF THE INVENTION

The present disclosure relates generally to a charging cable for electric vehicles, and more specifically, a non-fluid cooled charging cable for electric vehicles.

### BACKGROUND OF THE INVENTION

Electric vehicles (EVs) operate on battery power stored in on-board batteries. The batteries are recharged using power supplied from a power grid. There are a number of “levels” of charging. Level 1 charging uses standard, e.g., residential electrical power (120V), which can take many hours to fully charge a vehicle's battery. Level 2 charging uses 220-204V and can often be found in residential, retail, and office charging stations. Level 2 charging can fully charge a vehicle over the course of a workday or night. The most efficient charging is Level 3 charging using “fast chargers” that can charge a vehicle to 80% or more in about 30 minutes and fully charge a vehicle in about 60 minutes.

It will, however, be appreciated that fast chargers operate at high power levels that require that the cables between the charging station and the vehicle be cooled. Traditional fast charging systems rely on fluid cooling tubes to cool the cables and connectors (the connectors between the cables and the vehicle) due to the heat generated by the power draw. This allows the cables to be “handled” by individuals during charging.

Accordingly, there is a need for a fast charge cable that does not require fluid to maintain the cables and connectors cool to allow handling the cable.

### SUMMARY OF THE INVENTION

According to an embodiment, a fast-charge EV cable requires no cooling coils or fluid. In an embodiment, the cable includes an insulated conductor, a binder, a thermal layer, and a jacket positioned around the thermal layer. In an embodiment, the thermal layer is a synthetic porous material having extremely low density and extremely low thermal conductivity. One suitable thermal layer is a thermal blanket, formed as a blanket having an outer layer and an aerogel material. The outer layer can be, for example, a fiberglass material.

In an embodiment, the cable includes two insulated conductors and the conductors can be cabled. The cable can include more than two insulated conductors.

In some embodiments, the binder is positioned around the cabled conductors, the thermal layer is positioned around the binder, and the jacket is positioned around the thermal layer. The binder can be a mica-based material such as a mica tape. The tape can be applied over the conductors in an overlap. One suitable overlap is a 25 percent overlap. The jacket can be an abrasion and cut resistant material, such as a polymeric material, such as a thermoplastic polyurethane material. In one or more embodiments, the jacket has a nominal wall thickness of about 0.120 inches. Other suitable jacket materials include, for example, thermoset materials. Other suitable jacket thicknesses, as well as materials, will be appreciated by those skilled in the art.

In embodiments, the conductors are flexible, tinned, extruded copper conductors. The conductors can be, for example, 2/0 AWG, flexible, tinned, extruded copper class K conductors. In other embodiments, the conductors are 4/0 AWG flexible, tinned, extruded copper class K conductors. An example of a 2/0 AWG conductor is a 1323/30 stranding conductor; an example of a 4/0 AWG conductor is a 1995/30 stranding conductor. Other gauge suitable conductors will be recognized by those skilled in the art.

In one or more embodiments, the cable includes two insulated conductors, each conductor including a thermal layer positioned around the insulated conductors and the conductors with the thermal layers are cabled to form an assembly with the binder positioned around the assembly, and the jacket positioned around the binder.

In one or more embodiments, the cable includes two insulated conductors, each conductor including a thermal layer positioned around the insulated conductors with the conductors and thermal layers cabled to form an assembly. In such embodiments, the binder is positioned around the assembly, a further thermal layer is positioned around the binder, and the jacket is positioned around the further thermal layer.

In another embodiment, the cable includes an insulated conductor, an air channel, and a jacket. The insulated conductor may include an insulator surrounding a conductor. The air channel may provide airflow that may transfer heat away from the insulated conductor. The jacket may surround the insulated conductor and air channel.

In an embodiment, the cable includes a silicon spacer. The silicon spacer may be adjacent to the insulated conductor.

In an embodiment, the conductor may include two conductors, and the two conductors may include silicon surrounding and coupling the two conductors.

In an embodiment, the conductor may include at least one gap that may include the air channel.

In an embodiment, the insulator may include at least one gap that may include an air channel.

In an embodiment, the cable may include at least one air tube, at least one air tube may be located adjacent to the insulated conductor, and may include the air channel.

In an embodiment, at least one air tube may include an aluminum air tube.

In an embodiment, the insulated conductor and the at least one air tube may be cabled.

In an embodiment, at least one air tube may include airflow in one direction.

In an embodiment, at least one air tube may include a first air tube and a second air tube. The first air tube and second air tube may include air flow in opposite directions.

In various embodiments,

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 is a cross-sectional diagram of an example embodiment of a fast charge cable, according to one or more aspects described herein;

FIG. 2 is a cross-sectional diagram of another example embodiment of a fast charge cable, according to one or more aspects described herein;

FIG. 3 is a cross-sectional diagram of still another example embodiment of a fast charge cable, according to one or more aspects described herein;

FIG. 4 is a cross-sectional diagram of still another example embodiment of a fast charge cable, according to one or more aspects described herein;

FIG. 5 is a cross-sectional diagram of still another example embodiment of a fast charge cable, according to one or more aspects described herein;

FIG. 6 is a cross-sectional diagram of still another example embodiment of a fast charge cable, according to one or more aspects described herein;

FIG. 7 is a cross-sectional side view of the example fast charge cable depicted in FIG. 4, according to one or more aspects described herein;

FIG. 8 is a cross-sectional side view of the example fast charge cable depicted in FIG. 5, according to one or more aspects described herein;

FIG. 9 is a cross-sectional side view of the example fast charge cable depicted in FIG. 6, according to one or more aspects described herein;

FIG. 10 illustrates a simplified schematic view of an example charging station using fast charge cable, according to one or more aspects described herein;

FIG. 11 illustrates a schematic view of an example force air cooling system, according to one or more aspects described herein;

FIGS. 12A-D illustrate various cross-sectional views of example fast charge cable, according to one or more aspects described herein;

FIGS. 13A-D illustrate various cross-sectional views of example fast charge cable, according to one or more aspects described herein;

FIG. 14 illustrates a simplified schematic view of an example charging station using coupler assembly, according to one or more aspects described herein; and

FIG. 15 illustrates a simplified schematic view of an example charging station using fast charge cable including helical air pockets, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

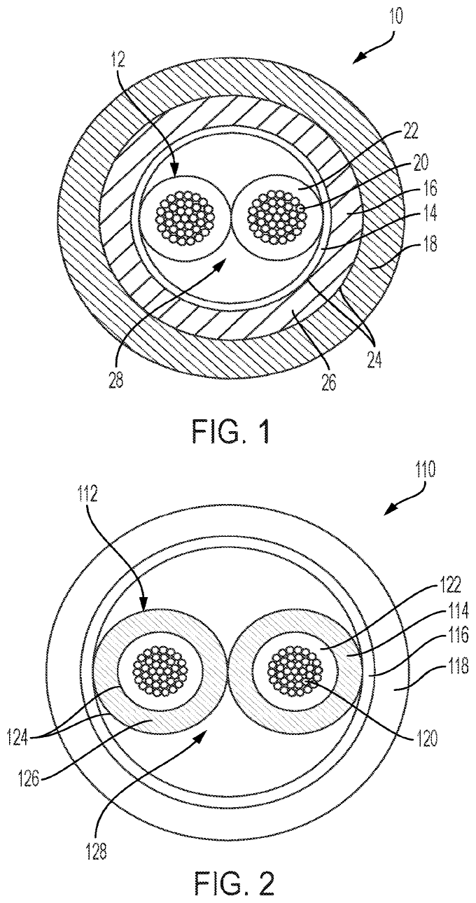

FIG. 1 is a cross-sectional diagram of an embodiment of a non-fluid cooled electric vehicle (EV) fast-charge cable 10 for electric vehicles, according to one or more aspects described herein. Cable 10 includes an insulated conductor 12, a binder 14, a thermal layer 16, and a jacket 18. In the illustrated embodiment, the insulated conductor 12 includes a conductor 20, such as a flexible, tinned extruded copper conductor, such as a 2/0 AWG tinned copper class K conductor. One suitable flexible, tinned extruded copper conductor is a 2/0 AWG (1323/30 stranding) conductor. Insulation 22 is present on conductor 20. An insulation such as a thermoset heat resistant material, such as a silicone rubber insulation having, for example, a minimum average wall of 0.080 inches. In an embodiment, two insulated conductors 12 are used. The insulated conductors 12 are cabled (twisted) with a left-hand lay. Cable 10 may include more than two insulated conductors 12.

The binder 14 is positioned around the insulated conductors 12. In an embodiment, binder 14 is a tape, such as a mica tape. One suitable mica tape is a 0.005-inch thick mica tape. The tape may be applied in an overlap. One suitable overlap is a 25 percent overlap.

The thermal layer 16 is positioned around the binder tape 14. A suitable thermal layer 16 is a thermal blanket or bedding and includes a solid with extremely low density and extremely low thermal conductivity, such as an aerogel-based thermal blanket in which a fiberglass material 24 encases the aerogel material 26. The aerogel material 26 is a synthetic porous ultralight material derived from a gel, in which the liquid component for the gel has been replaced with a gas without significant collapse of the gel structure. In an embodiment, the thermal layer blanket 16 has a nominal wall thickness of about 0.300 inches.

Jacket 18 is positioned around the thermal blanket 16. Jacket 18 can be, for example, an abrasion and cut resistant material, such as a polymeric material, such as thermoplastic polyurethane (TPU) material. Other suitable jacket materials include thermoset materials. One current jacket 18 is a TPU material having a nominal wall thickness of about 0.120 inches.

A current EV cable 10 construction has two insulated conductors 12 in which the conductors 20 (bare) have a nominal diameter of about 0.48 inches and the insulation 22 has a minimum average wall of 0.080 inches. The two insulated conductors 12, again cabled with a left-hand lay, form an assembly 28, having a nominal diameter of about 1.288 inches. The assembly 28 with the binder tape 14 applied in an overlap, such as a 25 percent overlap, has a nominal diameter of about 1.301 inches. With the thermal blanket 16, the nominal diameter is about 1.908 inches, and with jacket 18 positioned over the thermal blanket 16, which forms the EV cable 10, the nominal diameter is about 2.155 inches.

FIG. 2 illustrates an alternate embodiment of an EV cable 110, according to one or more aspects described herein. In this embodiment, cable 110 includes an insulated conductor 112, a thermal layer 114, a binder 116, and a jacket 118. In the illustrated embodiment, the insulated conductor 112 includes a conductor 120, such as a 4/0 AWG (1995/30 stranding) tinned copper class K conductor. Insulation 122 is present on the conductor 120, such as a thermoset heat resistant material, such as silicone rubber insulation having a minimum average wall of 0.080 inches.

The thermal layer 114 is positioned around the insulated conductor 112. A suitable thermal layer 114 is a thermal blanket or bedding formed from a solid with extremely low density and extremely low thermal conductivity, such as an aerogel-based thermal blanket in which a fiberglass material 124 encases the aerogel material 126. The aerogel material 126 is a synthetic porous ultralight material derived from a gel, in which the liquid component for the gel has been replaced with gas without significant collapse of the gel structure. In an embodiment, the thermal layer blanket 114 has a nominal wall thickness of about 0.300 inches.

In the illustrated embodiment, two insulated conductors 112 with individual thermal layers 114 are used, the conductors 112 with the thermal layers 114 are cabled (twisted) with a left-hand lay. The two conductors 112 with the thermal layers 114 define an assembly 128.

The binder 116 is positioned around assembly 128 (the conductors 112 with the thermal layers 114). In an embodiment, the binder 116 is a tape, such as a mica tape. One suitable mica tape is a 0.005-inch thick mica tape. The tape may be applied in an overlap, such as a 25 percent overlap.

Jacket 118 is positioned around binder 116. The jacket 118 can be, for example, an abrasion and cut resistant material, such as a polymeric material, such as a TPU material having a nominal wall thickness of about 0.120 inches. Other suitable jacket materials include thermoset materials; other suitable jacket thicknesses will be appreciated by those skilled in the art.

The illustrated EV cable 110 construction has two insulated conductors 112 in which the conductors 120 (bare) have a nominal diameter of about 0.549 inches and the insulation 122 has a minimum average wall of 0.080 inches.

In this embodiment, a thermal blanket 114 is positioned around each of the individual insulated conductors 112. The thermal blankets 114 each have a nominal wall thickness of about 0.300 inches, and the insulated conductors 112 with the blankets 114 each have a nominal diameter of about 1.32 inches. The two conductors 112 with their thermal blankets 114 are cabled with a left-hand lay to form the assembly 128 having a nominal diameter of about 2.641 inches, and the binder tape 116 is positioned over the assembly 128 at an overlap, such as a 25 percent overlap with an overall nominal diameter of about 2.649 inches.

The jacket 118, for example, an abrasion and cut resistant material, such as a polymeric material, such as a TPU material jacket 118, is positioned around the binder 116, with the resulting cable 110 having a nominal diameter of about 2.895 inches. Other suitable materials include, for example, thermoset materials; other suitable jacket thicknesses will be appreciated by those skilled in the art.

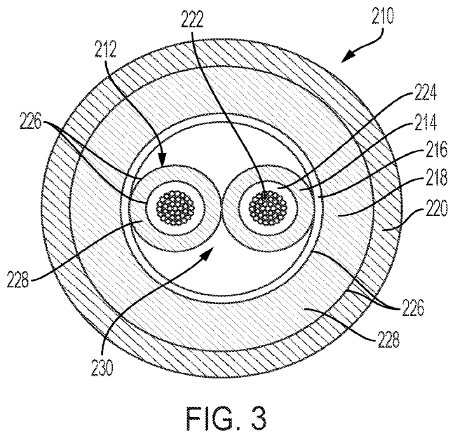

FIG. 3 illustrates still another alternate embodiment of an EV cable 210, according to one or more aspects described herein. In this embodiment, which is similar to the embodiment of FIG. 2, cable 210 includes an insulated conductor 212, a thermal layer 214, a binder 216, another (or additional) thermal layer 218, and a jacket 220. In the illustrated embodiment, the insulated conductor 212 includes a conductor 222, such as a flexible, tinned extruded 4/0 AWG copper class K conductor. One such conductor is a flexible, tinned extruded 4/0 AWG (1995/30 stranding), copper class K conductor. Insulation 224 is present on the conductor 222, such as a thermoset heat resistant material, such as silicone rubber insulation having, for example, a minimum average wall of 0.080 inches.

The thermal layer 214 is positioned around the insulated conductor 212. A suitable thermal layer 214 is a thermal blanket or bedding, such as a solid with extremely low density and extremely low thermal conductivity, such as an aerogel-based thermal blanket in which a fiberglass material 226 encases the aerogel material 228. The aerogel material 228 is a synthetic porous ultralight material derived from a gel, in which the liquid component for the gel has been replaced with a gas without significant collapse of the gel structure. In an embodiment, the thermal layer blanket 214 has a nominal wall thickness of about 0.300 inches.

In the illustrated embodiment, two insulated conductors 212 with individual thermal layers 214 are used. The conductors 212 with the thermal layers 214 are cabled (twisted) with a left-hand lay. The two conductors 212 with their thermal layers 214 define an assembly 230.

The binder 216 is positioned around assembly 230 (the conductors 212 with their thermal layers 214). In an embodiment, the binder 216 is a tape, such as a mica tape. One suitable mica tape is a 0.005-inch thick mica tape. The tape may be applied in an overlap, such as a 25 percent overlap.

The second thermal layer 218 is positioned around assembly 230. The second thermal 218 layer has a nominal wall thickness of about 0.300 inches, and jacket 220 is positioned around the second thermal layer 218. The jacket 220 can be, for example, an abrasion and cut resistant material, such as a polymeric material, such as a TPU material having a nominal wall thickness of about 0.120 inches. Other suitable jacket materials include, for example, thermoset materials; other suitable jacket thicknesses will be appreciated by those skilled in the art.

The illustrated EV cable 210 construction has two insulated conductors 212 in which the conductors 222 (bare) have a nominal diameter of about 0.549 inches and the insulation 224 has a minimum average wall thickness of 0.080 inches.

In this embodiment, thermal blankets 214 are positioned around each of the individual insulated conductors 212. The thermal blankets 214 each have a nominal wall thickness of about 0.300 inches, and the insulated conductors 212 with their blankets each have a nominal diameter of about 1.32 inches. The two conductors 212 with their thermal blankets 214 are cabled with a left-hand lay to form the assembly 230, which has a nominal diameter of about 2.641 inches. The binder tape 216 is positioned over the assembly 230. The binder tape 216 can be positioned over the assembly 230 in an overlap, such as a 25 percent overlap with an overall nominal diameter of about 2.649 inches.

The second thermal blanket 218 is positioned over the binder tape 216 and the assembly 230 with binder tape 216, and second thermal blanket 218 has a nominal diameter of about 3.257 inches. The jacket 220, for example, an abrasion and cut resistant material, such as a polymeric material, such as a TPU material jacket 220, is positioned around the second thermal blanket 218 and the resulting cable 210 has a nominal diameter of about 3.503 inches. Other suitable jacket materials include, for example, thermoset materials; other suitable jacket thicknesses will be appreciated by those skilled in the art.

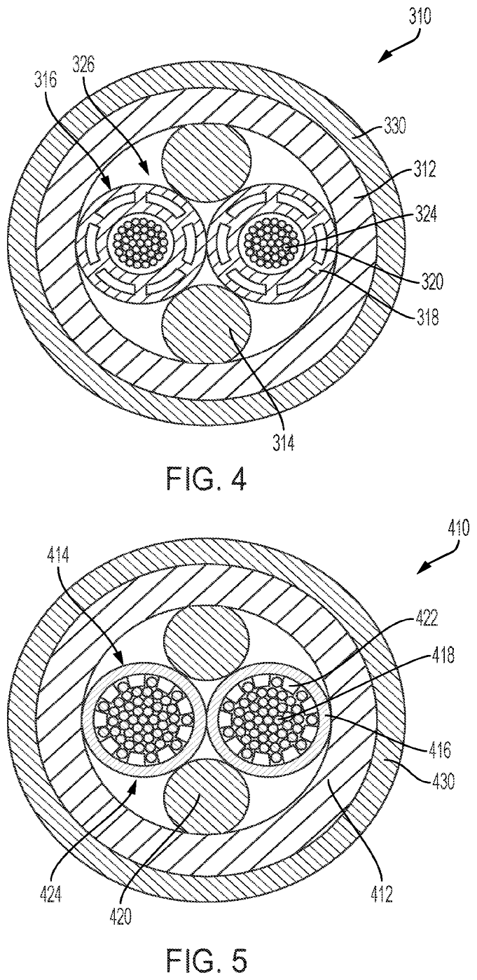

FIG. 4 illustrates still another alternate embodiment of an EV cable 310, according to one or more aspects described herein. In this embodiment, cable 310 includes insulated conductor 316, a silicon spacer 314, a layer 312, and a jacket 330. Layer 312 may include a binder and/or a thermal layer. In the illustrated embodiment, the insulated conductor 316 includes a conductor 324, such as a 4/0 AWG (1995/30 stranding) tinned copper class K conductor. Insulation 318 is present on the conductor 324, such as a thermoset heat resistant material, such as silicone rubber insulation.

Insulation 318 includes at least one gap 320 that defines an air channel. Gap 320 may include multiple gaps that surround the conductor 324 and allow for heat to move from the conductor 324 to and through the gaps 320 while maintaining sufficient structural integrity or strength to prevent the gaps from collapsing under pressure.

Gaps 320 allow air to flow within the insulation 318 and move heat away from the conductor 324 to limit the heat from transferring to layer 312 and jacket 330. The airflow, for example, may move the heat generated in the conductor 324 through cable 310 and out of one end of the cable. For example, air could come into cable 310 at the charging end, the end that connects to the EV and is handled by a user, and the air could flow through cable 310 within gaps 320 and flow out of the other end of cable 310. Thus, moving heat generated from conductor 324 away from the conductor and limiting heat transferring to layer 312 and jacket 330. The heat transfer could, for example, be limited to the air channels, such that little heat is transferred to layer 312 and jacket 330. Furthermore, since air comes in from the charging end of cable 310, the temperature of cable 310 would be lowest at the charging end compared to the outlet end of cable 310.

In the illustrated embodiment, two silicon spacers 314 and two insulated conductors 316 having insulation 318 with gaps 320 are used. The silicon spacers 314 and insulated conductors 316 can be cabled (twisted) with a left-hand lay. The two silicon spacers 314 and two insulated conductors 316 define an assembly 326.

Layer 312 is positioned around the assembly 326 (the conductors 324 with their insulation 318). In an embodiment, the layer includes a binder that is a tape, such as a mica tape. One suitable mica tape is a 0.005-inch thick mica tape. The tape may be applied in an overlap, such as a 25 percent overlap. Layer 312 may also include a thermal blanket that can be positioned around assembly 326. The thermal blanket may have a nominal wall thickness of about 0.300 inches, and jacket 330 is positioned around layer 312. The jacket 330 can be, for example, an abrasion and cut resistant material, such as a polymeric material, such as a TPU material. Other suitable jacket materials include, for example, thermoset materials; other suitable jacket materials will be appreciated by those skilled in the art.

The illustrated EV cable 310 construction has two silicon spacers and two insulated conductors 316 in which the conductors 324 (bare) have a nominal diameter of about 0.549 inches and the insulation 318 has a minimum average wall thickness of 0.080 inches with gaps 320 for airflow.

Silicon spacer 314 includes two silicon spacers positioned within the assembly 326 that provide structural support, which allows insulated conductor 316 space within the assembly 326 and little contact with layer 312. The silicon spacer may have a diameter between 14.6 mm to 16.7 mm.

In an embodiment, cable 310 may have a thickness of 5.21 mm.

In an embodiment, silicon spacer 314 has a diameter of 16.7 mm.

In an embodiment, cable 310 may have a diameter of 75.02 mm.

FIG. 5 illustrates still another alternate embodiment of an EV cable 410, according to one or more aspects described herein. In this embodiment, which is similar to the embodiment of FIG. 4, cable 410 includes insulated conductor 414, a silicon spacer 420, a layer 412, and a jacket 430. Layer 412 may include a binder and/or a thermal layer. In the illustrated embodiment, the insulated conductor 414 includes a conductor 418, such as a 4/0 AWG (1995/30 stranding) tinned copper class K conductor. Insulation 416 is present on the conductor 418, such as a thermoset heat resistant material, such as silicone rubber insulation.

Insulation 416 includes at least one gap 422 that define an air channel. Gap 422 include multiple gaps between individual conductors at the outer edge of conductor 418. Gaps 422 allow for heat to move from the conductor 418 to and through the gaps 422. Gaps 422 allow for a smaller cable 410 diameter as the gaps are within the conductor 418.

Gaps 422 allow air to flow between insulation 416 and conductor 418 and through the cable to limit the transfer of heat to layer 412 and jacket 430. The airflow, for example, may move the heat generated in the conductor 418 through cable 410 and out of one end of the cable. For example, air could come into cable 410 at the charging end, the end that connects to the EV and is handled by a user, and the air could flow through cable 410 within gaps 422 and flow out of the other end of cable 410. Thus, moving heat generated from conductor 418 away from the conductor and limiting heat transferring to layer 412 and jacket 430. The heat transfer could, for example, be limited to the air channels, such that little heat is transferred to layer 412 and jacket 430. Furthermore, since air comes in from the charging end of cable 410, the temperature of cable 410 would be lowest at the charging end compared to the outlet end of cable 410.

In the illustrated embodiment, two silicon spacers 420 and two insulated conductors 418 having insulation 416 with gaps 422 are used. The silicon spacers 420 and insulated conductors 414 are cabled (twisted) with a left-hand lay. The two silicon spacers 420 and two insulated conductors 414 define an assembly 424.

Layer 412 is positioned around assembly 424 (silicon spacers 420 and conductors 418 with their insulation 416). In an embodiment, the layer includes a binder that is a tape, such as a mica tape. One suitable mica tape is a 0.005-inch thick mica tape. The tape may be applied in an overlap, such as a 25 percent overlap. Layer 412 may also include a thermal blanket that can be positioned around the assembly 424. The thermal blanket may have a nominal wall thickness of about 0.300 inches, and the jacket 430 is positioned around layer 412. The jacket 430 can be, for example, an abrasion and cut resistant material, such as a polymeric material, such as a TPU material. Other suitable jacket materials include, for example, thermoset materials; other suitable jacket materials will be appreciated by those skilled in the art.

The illustrated EV cable 410 construction has two silicon spacers and two insulated conductors 414 in which the conductors 418 (bare) have a nominal diameter of about 0.549 inches and the insulation 416 has a minimum average wall thickness of 0.080 inches with gaps 422 for airflow.

Silicon spacer 420 includes two silicon spacers positioned within the assembly 424 that provide structural support, which allows insulated conductor 414 space within the assembly 424 and little contact with layer 412. The silicon spacer may have a diameter between 14.6 mm to 16.7 mm.

In an embodiment, cable 410 may have a thickness of 4.83 mm.

In an embodiment, silicon spacer 420 has a diameter of 14.6 mm.

In an embodiment, cable 410 may have a diameter of 66.21 mm.

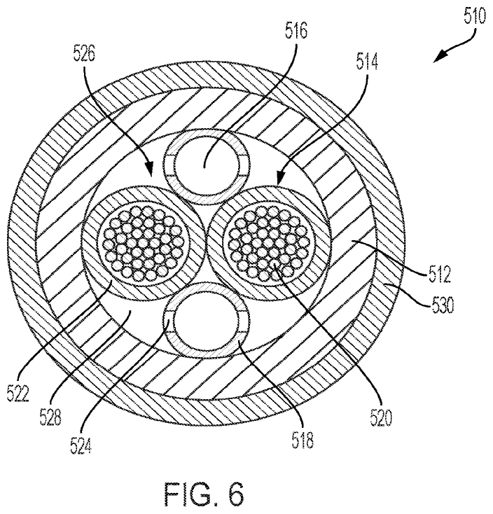

FIG. 6 illustrates still another alternate embodiment of an EV cable 510, according to one or more aspects described herein. In this embodiment, cable 510 includes air tube 518, insulated conductors 514, layer 512, and jacket 530. Layer 512 may include a binder and/or a thermal layer. In the illustrated embodiment, the insulated conductor 514 includes conductor 520, such as a 4/0 AWG (1995/30 stranding) tinned copper class K conductor. Insulation 522 is present on the conductor 520, such as a thermoset heat resistant material, such as silicone rubber insulation. Insulation 522 is positioned within the assembly 526 and provides structural support, which allows insulated conductor 520 space within the assembly 526 and little contact with layer 512.

Air tube 518 includes a tubular structure that defines an air channel 516. Air tube 518 further includes opening 524. Opening 524 allows air to flow in to and out of air tube 518, into a space 528 between insulated conductor 514 and air tube 518. Thus, air may flow through air tube 518 and into the space 528 between the insulated conductor 514 and the air tube 518, allowing for more heat to be transferred from the conductor 520. The air tube 518 may be made out of aluminum.

Air tube 518 allows air to flow away from the insulated conductor 514, through the cable 510, to limit the transfer of heat to layer 512 and jacket 530. The airflow, for example, may move the heat generated in the conductor 520 through cable 510 and out of one end of the cable. For example, air could come into cable 510 at the charging end, the end that connects to the EV and is handled by a user, and the air could flow through cable 510 within air tube 518 and flow out of the other end of cable 510. Thus, moving heat generated from conductor 520 away from the conductor and limiting heat transferring to layer 512 and jacket 530. In another embodiment, air may flow from the charging end of cable 510 through one air tube 518 to the other end of cable 510, where it is routed to a second air tube 518 on cable 510 and flows to the charging end of cable 510. Air tube 518 may be connected to a second air tube 518 in cable 510 using a tubular structure that bends and connects the ends of the air tubes 518. The tubular structure, at the bend, may include a cooling structure to further cool the airflow before being routed into the second air tube. The cooling structure, for example, may be a structure that is partially outside of jacket 530. The partially exposed structure can include a heat sink. In another example, the cooling structure may include a fan that forces chilled air into the tubular structure at the bend.

In an embodiment, air tubes 518 may allow for a smaller cable 510 diameter because there are no gaps or holes in the insulation 522 or conductor 514.

Layer 512 is positioned around assembly 526 (air tubes 518 and conductor 520 with insulation 522). In an embodiment, layer 512 includes a binder that is a tape, such as a mica tape. One suitable mica tape is a 0.005-inch thick mica tape. The tape may be applied in an overlap, such as a 25 percent overlap. Layer 512 may also include a thermal blanket that can be positioned around assembly 526. The thermal blanket may have a nominal wall thickness of about 0.300 inches, and jacket 530 is positioned around layer 512. The jacket 530 can be, for example, an abrasion and cut resistant material, such as a polymeric material, such as a TPU material. Other suitable jacket materials include, for example, thermoset materials; other suitable jacket materials will be appreciated by those skilled in the art.

In an embodiment, cable 510 may have a thickness of 4.32 mm.

In an embodiment, air tube 518 may have a diameter of 12.1 mm.

In an embodiment, cable 510 may have a diameter of 57.92 mm.

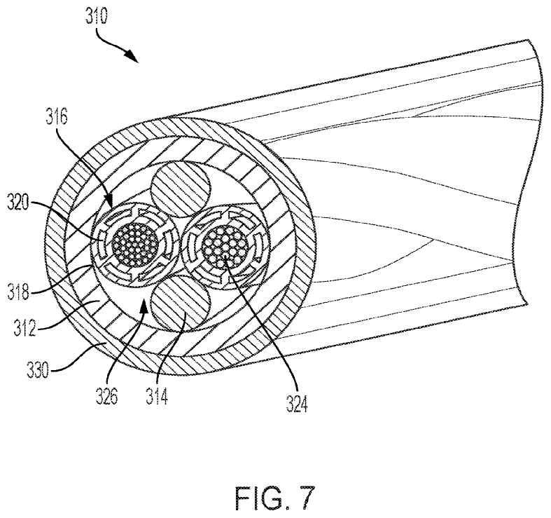

FIG. 7 illustrates a side view of the cable 310 of FIG. 4, according to one or more aspects described herein. Cable 310 includes insulated conductor 316, silicon spacer 314, layer 312, and jacket 330. Insulated conductor 316 includes conductor 324 and insulator 318 with gaps 320. Silicon spacers 314 and insulated conductors 316 are cabled (twisted) with a left-hand lay. Conductor 324 includes individual conductors that are cabled within insulator 318. Conductor 324, in FIG. 7, shows a conductor that is bare for illustrating how it is cabled (twisted).

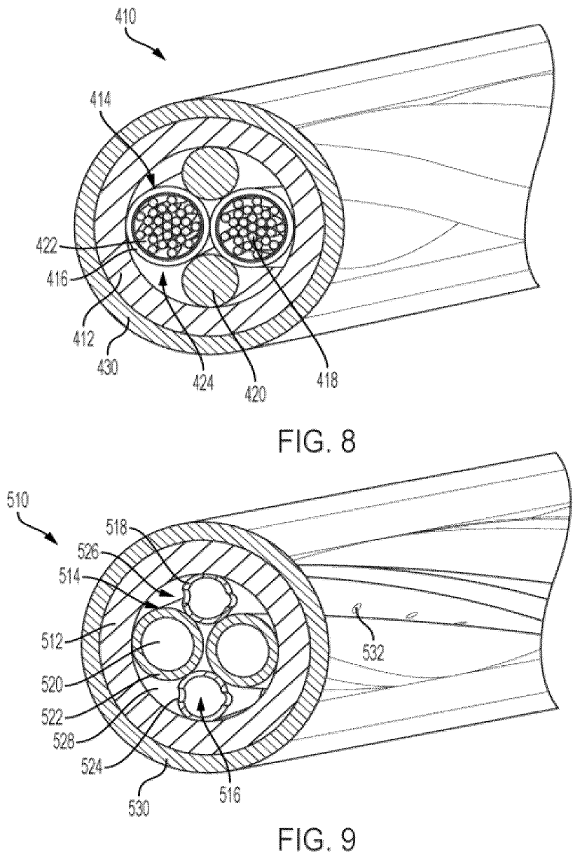

FIG. 8 illustrates a side view of the cable 410 in FIG. 5, according to one or more aspects described herein. Cable 410 includes insulated conductor 414, silicon spacer 420, layer 412, and jacket 430. Insulated conductor 414 includes conductor 418 and insulator 416 with gaps 422. Silicon spacers 420 and insulated conductors 414 are cabled (twisted) with a left-hand lay. Conductor 418 includes individual conductors that are cabled within insulator 416. Conductor 418, in FIG. 8, shows a conductor that is bare for illustrating how it is cabled (twisted).

FIG. 9 illustrates a side view of the cable 510 in FIG. 6, according to one or more aspects described herein. Cable 510 includes air tube 518, insulated conductor 514, layer 512, and jacket 530. Air tube 518 and insulated conductor 514 are cabled (twisted) with a left-hand lay. Conductor 520 may include individual conductors that are cabled within insulator 522. Air tube 518 includes openings 524 and 532 that allow air to flow into and out of assembly 526.

In one or more embodiments, the airflow may be increased using a fan or other device to force the movement of air into or out of the charging cable.

In one or more embodiments, the airflow may include chilled air, forced or natural flowing, into the cable. The chilled air, for example, may flow from the end of the cable that does not plug to the EV.

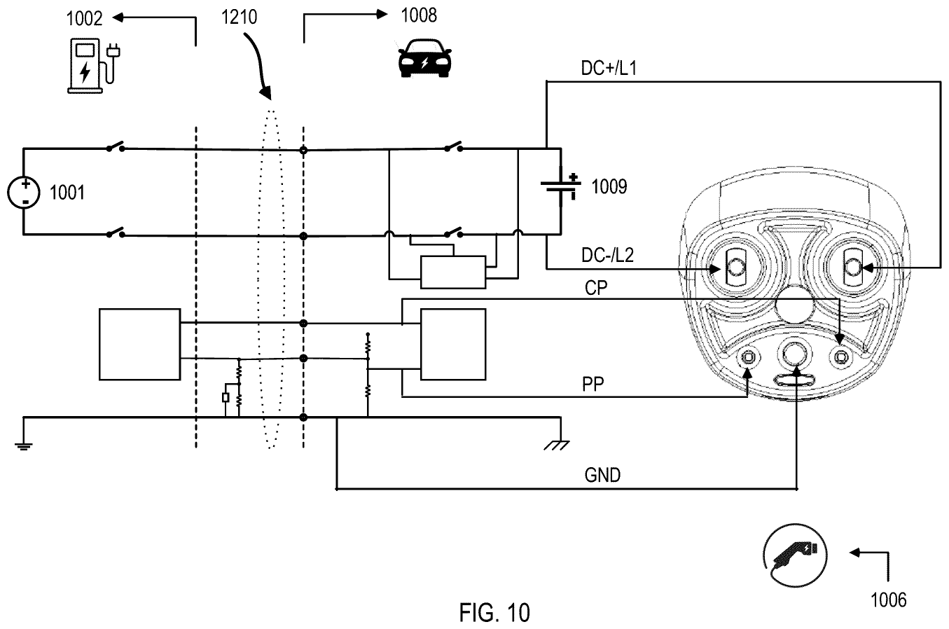

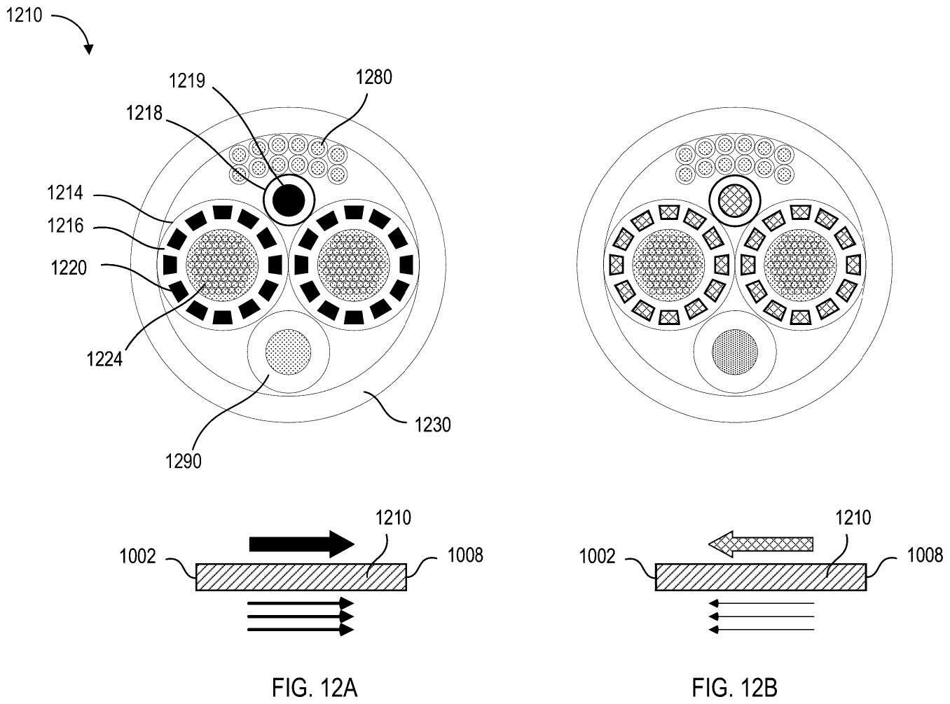

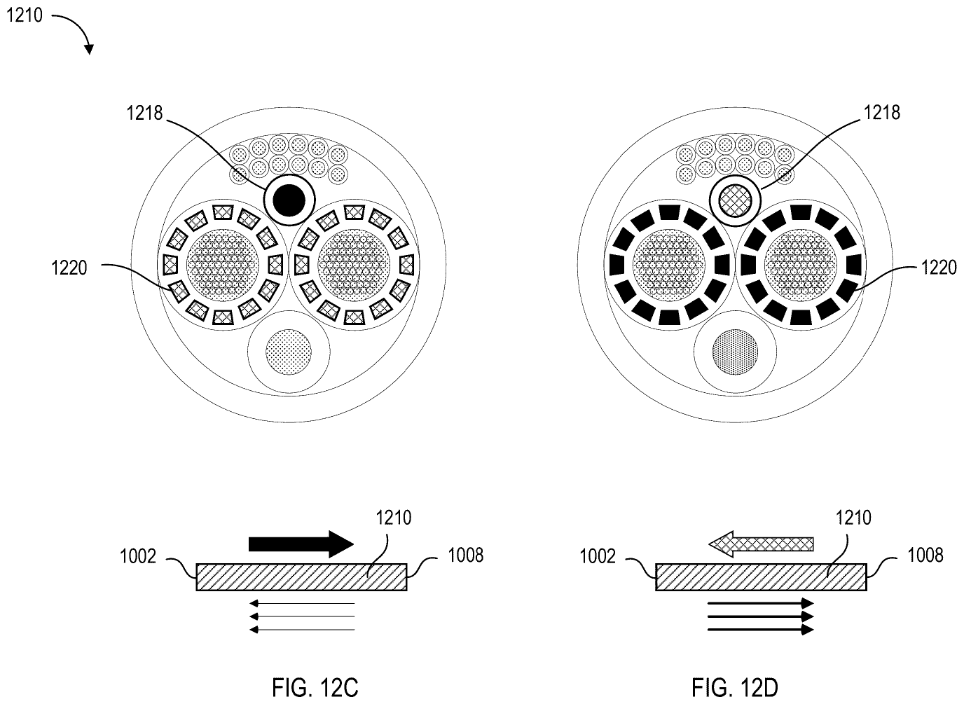

FIG. 10 illustrates a simplified schematic view of an example charging station using an EV cable 1210 (as depicted and described further herein, for example, with respect to FIGS. 12A-D), according to one or more aspects described herein. EV cable 1210 includes a charging station end 1002 (or earlier referred as “outlet end”) and a charging vehicle end 1008 (or “charging end”). According to an Electric Vehicle Charging Standard, for example, North American Charging Standard (NACS), EV cable 1210 may comprise two power conductors (e.g., DC+/L1 and DC−/L2), a ground conductor (“GND”), and signal conductors (e.g., CP, PP). DC+ and DC− may be positive/negative sides of DC voltage (or L1 and L2 for AC voltage) used for transferring power from a power source 1001 to charging load 1009 (e.g., vehicle battery) via a charging connector 1006 that connects to the charging vehicle and is handled by a user. Control Pilot (“CP”) may be used as a digital communication path between the charging station and charging vehicle. For example, the CP may use pulse width modulation to communicate regarding charging state and charging current. Power Line Communication may be superimposed onto the control pilot line while DC charging. Proximity Pilot (“PP”) may be a low voltage signal generated by various components and is used to determine the status of the vehicle connector. The ground conductor (“GND”) may provide a connection between earth and vehicle chassis.

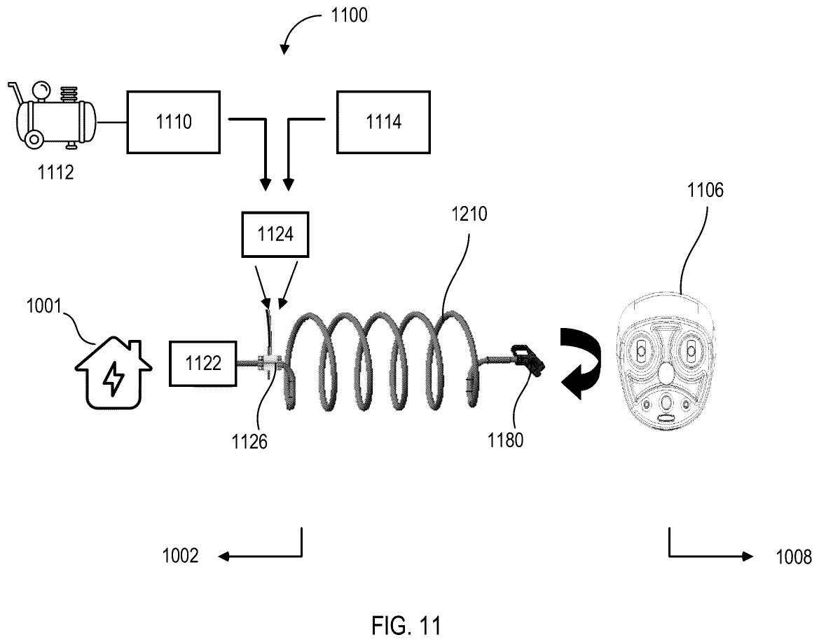

FIG. 11 illustrates a schematic view of an example force air cooling system 1100, according to one or more aspects described herein. In various embodiments, EV cable 1210 may be connected to and configured to interface with force air cooling system 1100. For example, force air cooling system 1100 may include a power source 1001, cooling pump 1110, air compressor 1112, power source inlet 1122, air adapter 1124, air inlet 1126, and/or one or more other components physically connected and/or communicatively linked to the force air cooling system 1100.

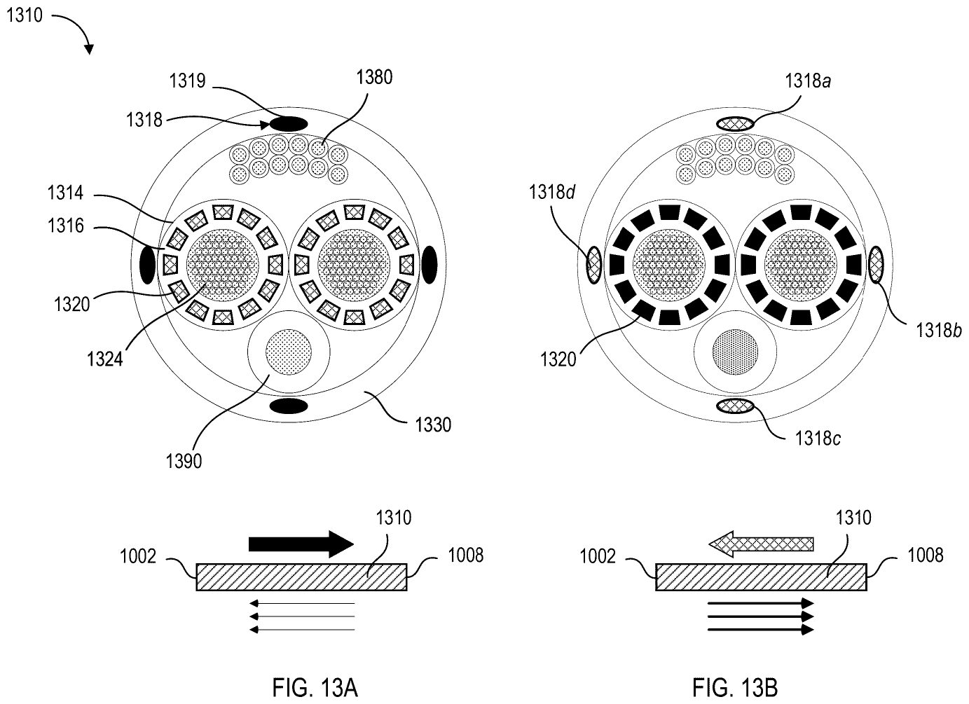

In various embodiments, force air cooling system 1100 may include a cooling pump 1110 to pressurize chilled air and provide the chilled air to EV cable 1210 via air channels. For example, a cooling pump 1110 may be configured to cools down the ambient air and provide pressurized chilled air to EV cable 1210 via air tube 1218 and/or one or more gaps 1220, which are described further herein with respect to FIGS. 12A-D and FIGS. 13A-D. The pressurized chilled air may then be directed or routed by a routing structure 1180 at the charging connector 1006. Such pressurized chilled air may absorb thermal energy generated by the conductors 1224. The routing structure 1180 at the charging connector 1006 directs (or bends) the air to the other air channels such an air tube 1218 or one or more gaps 1220 and flows back to the charging station end 1002. In some embodiments, force air cooling system 1100 may further be connected to a vacuum pump 1114 to enhance cooling efficiency.

FIGS. 12A-D illustrate various cross-sectional views of example EV cable 1210, according to one or more aspects described herein. In various embodiments, cable 1210 may include an air tube 1218, insulated conductors 1214 having one or more gaps 1220 therein, signal conductors 1280, and a ground conductor 1290 within a jacket 1230. In various embodiments, the insulated conductors 1214 may include conductor 1220 with insulation such as extruded silicone rubber insulation. In some embodiments, the signal conductors 1280 may include one or more pairs of flexible conductors such as 18 AWG. However, other gauge suitable conductors will be recognized by those skilled in the art.

As depicted in FIGS. 12A-B, in various embodiments, air tube 1218 may include a tubular structure that defines an air channel 1219 within the cable 1210. Air tube 1218 may be positioned in a space between insulated conductor 1214 and jacket 1230 to allow for heat generated by the conductors 1224 to be carried out of the cable 1210 while maintaining sufficient structural integrity or strength to prevent the air tube 1218 from collapsing under pressure. In some embodiments, air tube 1218 may further include one or more openings. In various embodiments, the air tube 1218 may be made of aluminum.

In various embodiments, air tube 1218 may allow forced chilled air to be injected from charging station end 1002 or charging vehicle end 1008 and flow through the cable 1210 to limit transfer of heat from conductors 1224 to jacket 1230. The cable 1210 may include any suitable number of air tube 1218 within the cable.

In various embodiments, insulated conductor 1214 may include one or more gaps 1220 that defines an air channel within the insulated conductor 1214. One or more gaps 1220 may be positioned to surround the conductors 1224 and allow for heat generated by the conductors 1224 to be carried out of the cable 1210 by forced air, while maintaining sufficient structural integrity or strength to prevent the one or more gaps from collapsing under pressure. In various embodiments, the one or more gaps 1220 may include any suitable number of gaps. In some embodiments, the one or more gaps 1220 may be equally spaced apart circumferentially around insulation 1216 of insulated conductor 1214. However, in other embodiments, the one or more gaps 1220 may be generally spaced apart circumferentially around insulation 1216 of insulated conductor 1214.

As depicted in FIG. 12A, chilled air may flow (or be pushed) into cable 1210 at the charging station end 1002, flow through cable 1210 via air tube 1218 and/or one or more gaps 1220. The chilled air pushed into cable 1210 absorbs thermal energy from the heat generated by the conductors 1224 and exhaust out of the charging vehicle end 1008 of the cable 1210. As a result, the heat (thermal energy) generated by the conductors 1224 may be carried away from the cable 1210 and limits the transfer of heat from the conductors 1224 to the jacket 1230. In some embodiments, as depicted in FIG. 12B, vacuum pump 1114 (shown in FIG. 11) may further be connected at the charging station end 1002 to pull the air from the cable 1210, via either air tube 1218 and/or one or more gaps 1220, to exhaust out of the charging station end 1002 of the cable 1210. Therefore, the heat generated by the conductors 1224 may be carried away from the cable 1210 and limits the heat transferring to the jacket 1230. In an alternative embodiment, chilled air may come (pushed) into cable 1210 at the charging vehicle end 1008, flow through cable 1210 via air tube 1218 and/or one or more gaps 1220, and exhaust out of the charging station end 1002 of the cable 1210.

The two air flow arrangements depicted in FIG. 12A-B, however, may generate noise at an air exiting end, i.e., charging station end 1002 or charging vehicle end 1008. Particularly, air flow arrangements shown in FIG. 12A may generate noise at the charging connector 1006. As described herein, cable 1210 may be configured to allow for improved control of a cooling process for the force air cooling system 1100. For example, force air cooling system 1100 may be configured to allow removing heat from the cable 1210 without noise at an air exiting end by routing (or returning back) the air to the charging station end 1002.

In some embodiments, as depicted in FIG. 12C, chilled air may flow at the charging station end 1002 through air tube 1218 to the charging vehicle end 1008 of cable 1210, where it is routed to one or more gaps 1220 of insulated conductor 1214 and flows back to the charging station end 1002. Air tube 1218 may be connected to the one or more gaps 1220 of insulated conductor 1214 using routing structure 1180 at the charging connector 1006 that directs (or bends) the air between the air tube 1218 and one or more gaps 1220. In other embodiments, as depicted in FIG. 12D, chilled air may flow at the charging station end 1002 through one or more gaps 1220 of insulated conductor 1214 to the charging vehicle end 1008 of cable 1210, where it is routed to air tube 1218 and flows back to the charging station end 1002.

FIGS. 13A-D illustrate various cross-sectional views of example EV cable 1310, according to one or more aspects described herein. In various embodiments, cable 1310 may include one or more air pockets 1318, insulated conductors 1314 having one or more gaps 1320 therein, signal conductors 1380, and a ground conductor 1390 within a jacket 1330. In various embodiment, the insulated conductors 1314 may include conductor 1320 with insulation such as extruded silicone rubber insulation. In some embodiments, the signal conductors 1380 may include one or more pairs of flexible conductors such as 18 AWG. However, other gauge suitable conductors will be recognized by those skilled in the art.

As depicted in FIGS. 13A-B, in various embodiments, one or more air pockets 1318 may include an oval (or elliptical) tubular structure that defines an air channel 1319 within the jacket 1330. One or more air pockets 1318 may be positioned in the jacket 1330 and circumferentially around the jacket to allow for heat transferred to the jacket 1330 to be carried away from the cable 1310, while maintaining sufficient structural integrity or strength to prevent the one or more air pockets 1318 from collapsing under pressure. In some embodiments, one or more air pockets 1318 may further include one or more openings.

In various embodiments, the one or more air pockets 1318 may include any suitable number of air pockets. For example, as depicted in FIG. 13D, the one or more air pockets 1318 may include four access openings 1318a, 1318b, 1318c, and 1318d. In various embodiments, the one or more air pockets 1318 may be equally spaced apart circumferentially around the jacket 1330. For example, an angle between neighboring air pockets of the four air pockets 1318a, 1318b, 1318c, and 1318d may be roughly 90 degrees, as depicted in FIG. 13D.

As depicted in FIG. 13A, chilled air may flow at the charging station end 1002 through one or more air pockets 1318 to the charging vehicle end 1008 of cable 1310, where it is routed to one or more gaps 1320 of insulated conductor 1314 and flows back to the charging station end 1002. One or more air pockets 1318 may be connected to the one or more gaps 1320 of insulated conductor 1314 using routing structure 1180 at the charging connector 1006 that directs (or bends) and connects air between the one or more air pockets 1318 and one or more gaps 1320. In other embodiments, as depicted in FIG. 13B, chilled air may flow at the charging station end 1002 through one or more gaps 1320 of insulated conductor 1314 to the charging vehicle end 1008 of cable 1310, where it is routed to one or more air pockets 1318 and flows back to the charging station end 1002.

In some embodiments, vacuum pump 1114 (as depicted in FIG. 11) may be connected at the charging station end 1002 to pull the air from the cable 1310 via one or more air pockets 1318 and/or one or more gaps 1320, and exhaust out of the charging station end 1002 of the cable 1310, in which the heat generated by the conductors 1324 may be carried away from the cable 1310 and limits the heat transferring to the jacket 1330.

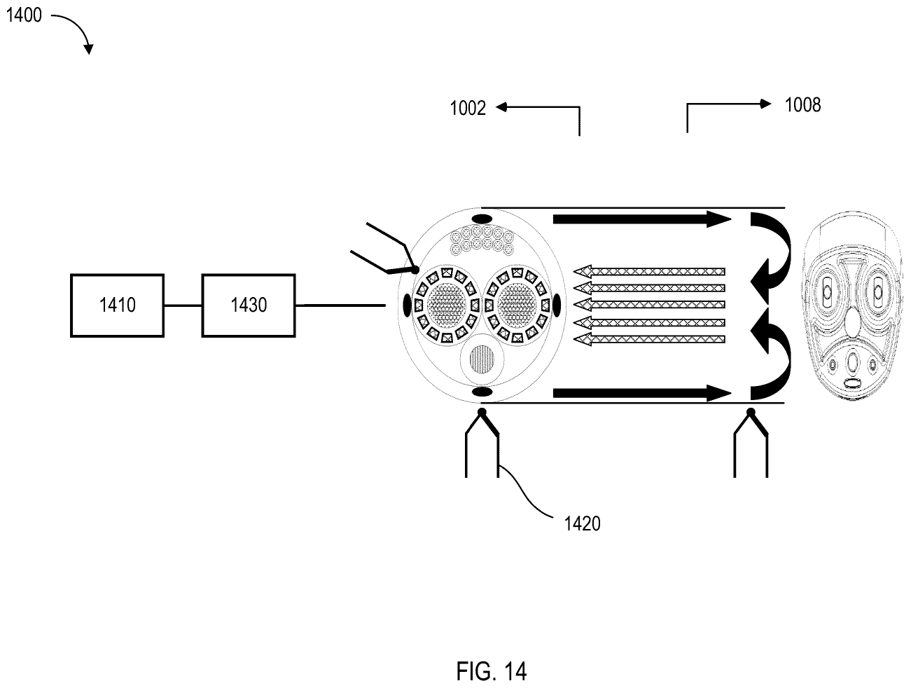

FIG. 14 illustrate perspective views of an example charging station using coupler assembly 1400, according to one or more aspects described herein. In various embodiments, coupler assembly 1400 of force air cooling system 1100 may be configured to utilize one or more of flow sensors 1410, temperature sensors 1420, various air coupling elements 1430 and/or other components of force air cooling system 1100 to identify and determine control parameters of the forced air flow to obtain optimal cooling efficiency. For example, one or more flow sensors 1410, one or more temperature sensors 1420 may be used to measure pressure drop, flow velocity, and/or temperature changes to determine suitable pressure, temperature ranges and/or sealing gasket material/arrangement. While laminar flow through air channels offer certain benefits regarding air flow control and predictability, the laminar flow may suffer from disadvantages such as low heat transfer rates. To enhance cooling efficiency, in some embodiments, chilled air may flow (pushed) into the cable in a rotational manner. The flow sensors may be used to measure rotational and/or turbulence status of forced air flow. For example, thrice-tweaked, air coupler for Roman Channel design including high temperature stability, ease-of-assembly features, rubber grommet sealing, and rotational air may be used to ensure balanced, non-cavitating pressure loading into the air channels. In other embodiments, one or more of flow sensors 1410, temperature sensors 1420, various air coupling elements 1430, and/or other components of force air cooling system 1100 may be used to measure or identify suitable alternative channels such as flat spacers and/or discrete tubes instead of extruded channels.

In some embodiments, coupler assembly 1400 may be configured to include channels in the jacket or a series of tubes immediately under the jacket around the EV core or a supporting structure that has a tube. This coupler may slide over the outside jacket and be grommet-compressed onto the core underneath in order to ensure proper air capture.

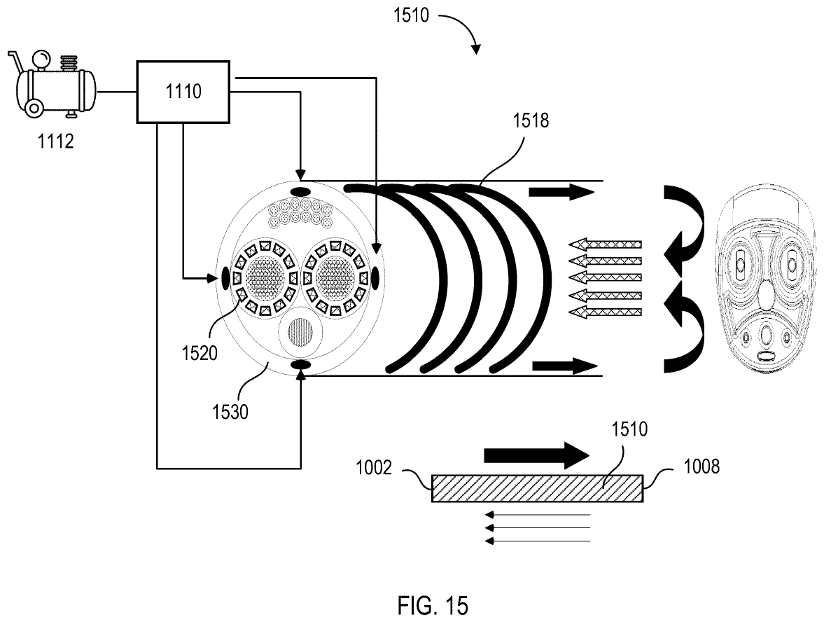

FIG. 15 illustrates perspective views of an example charging station using EV cable including helical air pockets, according to one or more aspects described herein. In various embodiments, cable 1510 may include one or more of helical air pockets 1518 to increase surface area of a helical air pockets of given dimensions. For example, one or more of helical air pockets 1518 may be helically arranged to increase heat transfer from the jacket 1530. As depicted in FIG. 15, in some embodiments, chilled air may flow at the charging station end 1002 through air tube 1518 to the charging vehicle end 1008 of cable 1510 using cooling pump 1110 and air compressor 1112, where it is routed to one or more gaps 1520 of insulated conductor and flows back to the charging station end 1002. In some embodiments, one or more of helical air pockets 1518 may be connected to the one or more gaps 1520 of insulated conductor using rerouting structure at the charging connector that directs (or bends) and connects air between the one or more of helical air pockets 1518 and one or more gaps 1520.

Those skilled in the art will appreciate the advantages of a fast-charge EV cable that does not require cooling coils, eliminating the cooling fluid, fluid connections, and potential leakage. Although certain materials for the insulation, binder, thermal blanket, and jacket are disclosed, those skilled in the art will recognize the other suitable materials that may be used for the fast-charge EV cable, which other materials are within the scope and spirit of the present disclosure. It will also be recognized that the various materials and layers in any disclosed embodiment may be used with others of the embodiments and that all such embodiments and variations thereof are within the scope and spirit of the present disclosure.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A cable for fast-charging an electric vehicle (EV), the cable having a charging station end and a vehicle end comprising:
an insulated conductor;
one or more gaps within insulation of the insulated conductor;
an air channel within an air tube; and
a jacket surrounding the insulated conductor and the air tube,
wherein the air tube positioned in a space between the insulated conductor and the jacket, and wherein the air channel and the one or more gaps provide air flow that transfers heat away from the insulated conductor.

2. The cable of claim 1, wherein air flowing from the charging station end through the air channel is routed to the one or more gaps at the vehicle end and flows back to the charging station end.

3. The cable of claim 1, wherein the air channel include a tubular structure within the cable.

4. The cable of claim 1, wherein the air channel and the one or more gaps receive pressurized chilled air at the charging station end.

5. The cable of claim 1, wherein the one or more gaps are positioned circumferentially around insulation of insulated conductor.

6. The cable of claim 5, wherein the one or more gaps are equally spaced apart circumferentially around insulation of insulated conductor.

7. The cable of claim 1, wherein the air tube is made out of aluminum.

8. The cable of claim 1, wherein air is configured to flow through the one or more gaps and the air channel in the same direction.

9. The cable of claim 1, further including signal conductors and a ground conductor within the jacket.

10. The cable of claim 1, wherein the air channel and the one or more gaps are connected to a vacuum pump to enhance cooling efficiency.

11. A cable for fast-charging an electric vehicle (EV), the cable having a charging station end and a vehicle end comprising:
an insulated conductor;
one or more gaps within insulation of the insulated conductor;
a jacket surrounding the insulated conductor;
one or more air pockets within the jacket; and
wherein the one or more air pockets and the one or more gaps provide air flow that transfers heat away from the insulated conductor.

12. The cable of claim 11, wherein air flowing from the charging station end through the one or more gaps is routed to the one or more air pockets at the vehicle end and flows back to the charging station end.

13. The cable of claim 11, wherein the one or more air pockets include a tubular structure within the jacket.

14. The cable of claim 11, wherein the one or more air pockets and the one or more gaps receive pressurized chilled air at the charging station end.

15. The cable of claim 11, wherein the one or more air pockets are positioned circumferentially around the jacket.

16. The cable of claim 11, wherein the one or more air pockets are equally spaced apart circumferentially around the jacket.

17. The cable of claim 11, wherein the one or more of air pockets are helically arranged to increase heat transfer from the jacket.

18. The cable of claim 11, wherein air is configured to flow through the one or more air pockets and the one or more gaps in the same direction.

19. The cable of claim 11, further including signal conductors and a ground conductor within the jacket.

20. The cable of claim 11, wherein the one or more air pockets and the one or more gaps are further connected to a vacuum pump to enhance cooling efficiency.
